(19) United States
(12) Patent Application Publication
(10) Pub. No.: US 2005/0038995 A1
(43) Pub. Date: Feb. 17, 2005

(54) File safety management system

(76) Inventor: Yang Chang Feng, Taichung City (TW)

Correspondence Address: CHARLES E. BAXLEY, ESQUIRE, Third Floor, 90 John Street, New York, NY, 10038, US

(21) Appl. No.: 10/640,208

(22) Filed: Aug. 12, 2003

(51) Int. Cl. H04L 9/00

(52) U.S. Cl. 713/165

(57) ABSTRACT

A file safety managerial system includes a backend file server for saving original files, the backend file server cooperates with an isolating and protecting device and a user sever so as to accomplish access files control. The user sever has a virtual operating section and an endorsement processing section, through the cooperation of the above-mentioned devices, the files safety managerial system of the present invention is capable of protecting the original files, implementing the endorsement processing and facilitating the file management in case that the original files are being shared by several users.

### BACKGROUND OF THE INVENTION

1. Field of The Invention

The present invention relates to a file managerial system, and more particularly to a file safety managerial system which includes a backend file server for saving original files, the backend file server cooperates with an isolating and protecting device and a user sever so as to implement access files control. The user sever has a virtual operating section and an endorsement processing section, through the cooperation of the above-mentioned devices, the file safety managerial system of the present invention is capable of protecting the original files, implementing file endorsing and commenting as well as facilitating the file management in case that the original files are being shared by multi-computers of user side.

2. Description of the Prior Arts

Conventional file sharing system is shown in FIG. 1 and generally including a sever 10 for saving original files, and a plurality of computers 11 are accessible to the files via network, such that the original files may be shared by many users. Although most of the servers 10 are protected by a firewall 12, every user side computer 11 passed the firewall 12 is able to revise the original files in the sever 10, and as a result, some problems will be caused as follows:

First, despite the files in the server 10 are isolated and protected by the firewall 12, every user side computer 11 passed the firewall 12 is still able to revise the original files in the server 10, also this is the reason why the computer hackers are concentrating themselves on breaking firewall 12. Every user who passed the firewall 12 can trace the location of the original files in the server 10 very easily. It is impossible to protect the security of the original files since the server 10 cannot be isolated from the users who passed the firewall 12.

Second, every computer 11 of user side passed firewall 12 can open, revise and save any system resources (files), the server 10 is unable to guarantee the safety of the original files at all, it will affect the original files (files are damaged or lost) once the network sharing system is wrong, and any revision on the shared files cannot be recorded and traced, only the latest revision is preserved and the original files are lost and cannot be display anymore.

Third, the original files in the sever 10 are limited by the original modality and cannot be noted and commented (or unable to note and comment the original files without revising them). In this case, the conventional file sharing system is not suitable for online file-endorsement processing. Many companies have to additionally set up an electronic signing and sealing system as well as electronic authentication system, thus the cost is much increased.

Fourth, the files shared and processed by the network can be printed, read, copied, and saved by every user side computer 11, in this case, the security of the files cannot be guaranteed.

The present invention has arisen to mitigate and/or obviate the afore-described disadvantages of the conventional file managerial system.

### SUMMARY OF THE INVENTION

The primary object of the present invention is to provide a file safety managerial system wherein an isolating and protecting device serves to completely isolate original files in a backend file server, and by taking use of user's server to set up a virtual operating platform on the basis of the original files in the backend file server. Such that enables the multi-user computers to realize a virtual file sharing via the user's sever, and ensures that the original files in the backend file server will not be affected by the system problems as well as the file sharing.

The secondary object of the present invention is to provide a file safety managerial system wherein the user's server is allowed to put notes and commentary to the files by method of producing layer style appended files based on the original files, the layer style appended files are preserved in the user's server and can be read and searched by users via the user side computers, such that implements internal file endorsing and commenting of a company online.

The third object of the present invention is to provide a file safety managerial system wherein the user's server sets up a virtual operating platform such that enables the user side computers to search and read files via the virtual operating platform, and with the help of the isolating and protecting device, the users are completed isolated from the original files, such that effectively protects the original files against traced, modified, printed, memorize and copied.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a schematic plan of instruments of a conventional file managerial system;

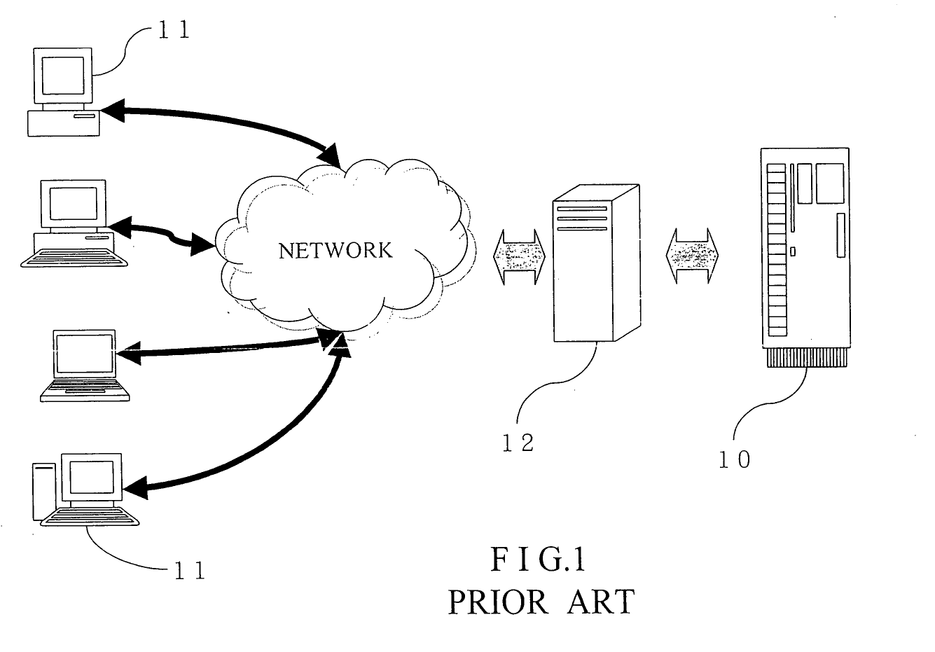

FIG. 2 is a schematic plan of a hardware configuration of a file safety managerial system of the present invention;

FIG. 3 is a files operating chart of the file safety managerial system of the present invention;

FIG. 4 is an illustrative diagram of an operating platform of the present invention.

### DETAILED DESCRIPTION OF THE PREFERRED EMBODIMENTS

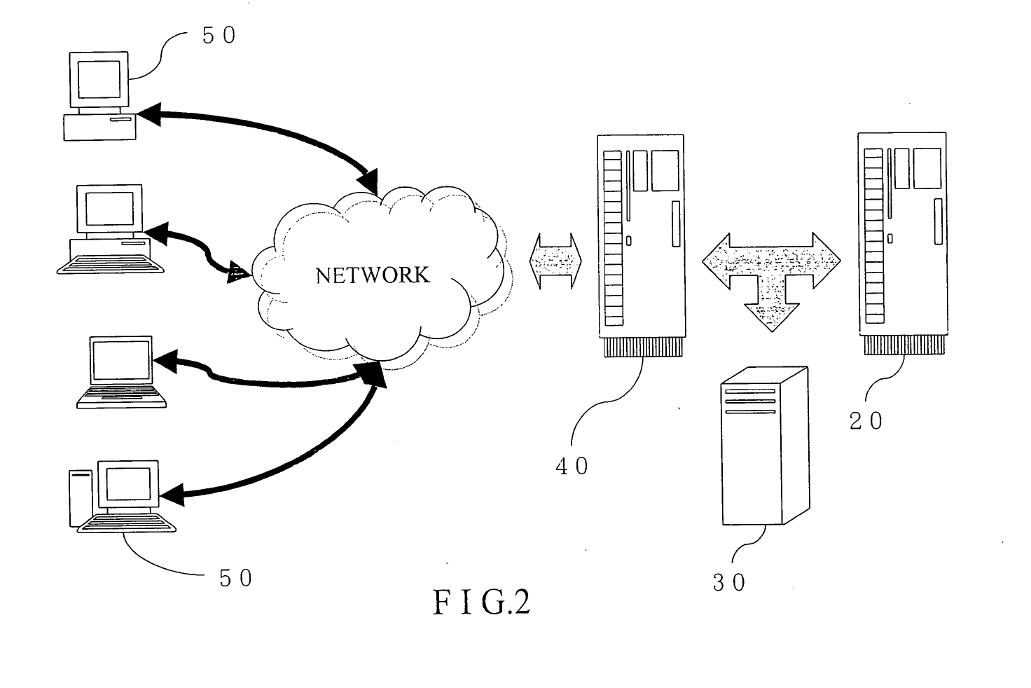

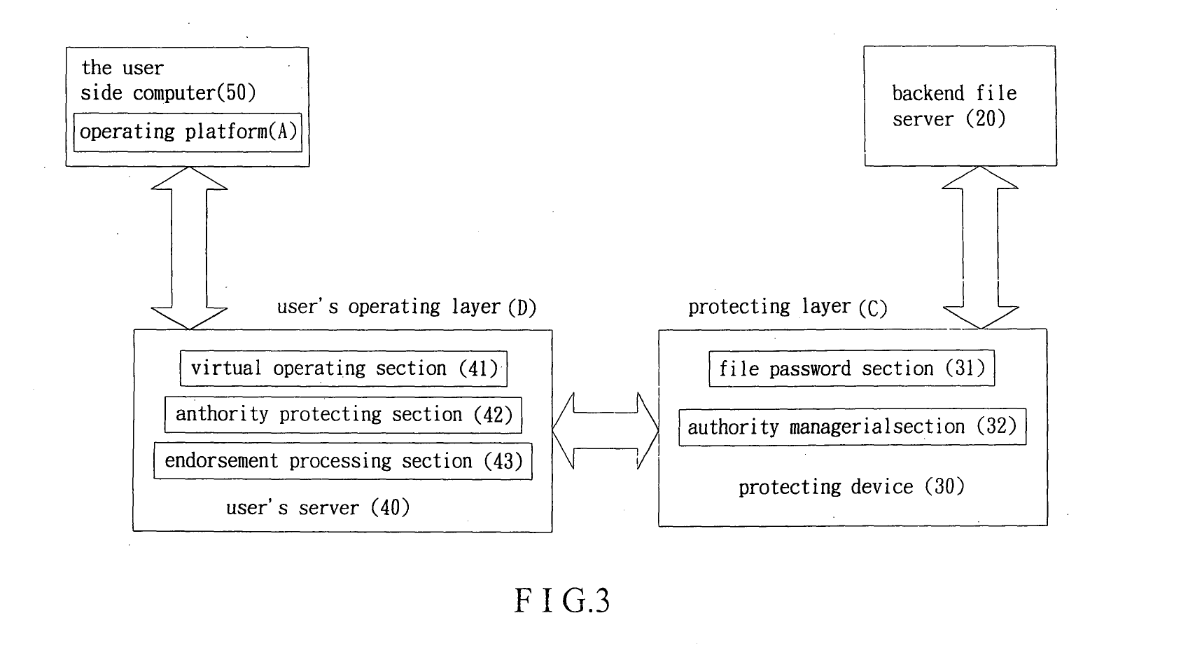

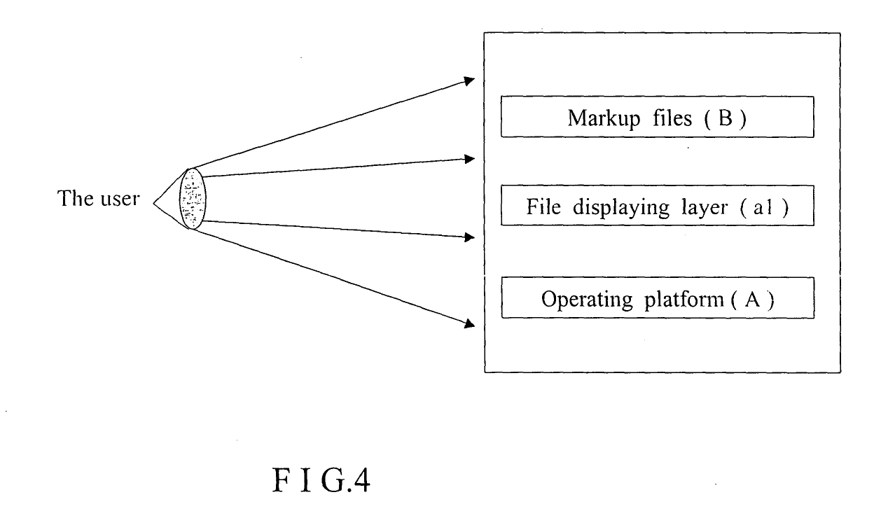

Referring to FIGS. 2-4, wherein FIGS. 2-3 is a schematic plan of a hardware configuration of the present invention and files operating chart. FIG. 4 is a chart of operating platform of the present invention. The file safety managerial system of the present invention is connected with plural computers 50 of user side via a network and generally includes:

A backend file server 20 is located at the endmost for saving the original files.

A protecting layer C which can be hardware or software, in this embodiment of the present invention it can be an isolating and protecting device 30 which cooperates with a software so as to form an isolating and protecting layer, and then connected with the backend file server 20 for guaranteeing the files against revision. Furthermore, a file password section 31 and an authority managerial section 32 will assist in access controlling.

A user's operating layer D, which is formed by a user sever 40 and software in accordance with the embodiment of the present invention. Which includes a virtual operating section 41, an authority protecting section 42 and an endorsement processing section 43. Wherein the virtual operating section 41 serves to provide operating platform A for user's reading. The operating platform A is capable of displaying the original files in the backend file server 20, while the authority protecting section 42 serves to guarantee the files to be displayed against being traced, modified, printed, memorize and copied. Furthermore, the authority protecting section 42 in the user's server 40 includes an endorsement processing section 43. The endorsement processing section 43 has a function of permitting the user with authority-protecting section's 40 approval to put notes and commentary to the files directly by a manner of layer style, and additionally produce an layer style appended file B. The appended file B is preserved in the user's sever 40 as well as the user side computer 50 according to the instruction of the authority protecting section 42, such that has no any influences on the original files.

When the user is using the user side computer 50 to connect with the user's server 40 via network, the authority protecting section 42 in the user server 40 will confirm the authority of the user first, only the authorized user can open the virtual operating section 41 and unauthorized user will be rejected. After the virtual operating section 41 is opened, it will provide an operating platform A. In this embodiment of the present invention, the operating platform A is a combination of a displayer with software. By taking use of the virtual operating section 41 as well as the authority protecting section 42, the user is able to get access to the isolating and protecting device 30 and fetch the original files in the backend file server 20. A file displaying layer (a1) in the operating platform A serves to display the original files for user's reading. At the moment, the user can read the original files via the file displaying layer (a1), however, between the original files and the files displaying layer (a1) the authority protecting section 42 is defined for guaranteeing the original files against being traced, modified, printed, memorize and copied. And alike, the user's malicious modality as well as encroachment will be blocked by an isolating layer produced by the isolating and protecting device 30. Thereby the original files in the backend file server 20 are very safe and can be effectively guaranteed against any unauthorized modification.

In case that the user want to put notes or commentary to the files, he/she can do it directly on the file displaying layer (a1) of the operating platform A by taking use of the endorsement processing section 43 and additionally produce a layer style appended file B which will be preserved in the user's sever 40 as well as the user side computer 50 based on the instruction of the authority protecting section 42, such that has no any influences on the original files. Furthermore, the users in the same company are permitted to search and read different layer style appended files B via the user server 40, so as to effectively improve the information transmitting efficiency inside of the company without affecting the original files.

While we have shown and described various embodiments in accordance with the present invention, it should be clear to those skilled in the art that further embodiments may be made without departing from the scope of the present invention.

1. A file safety managerial system for safely providing shared files for multi-computers of user side via network, which including:
a backend file server defined at the endmost for saving original files;
a protecting layer connected with the backend file server for guaranteeing the files in it against revision;
a user's operating layer formed by a user sever and including a virtual operating section, an authority protecting section and an endorsement processing section, the virtual operating section serving to provide an operating platform for user's reading, the operating platform capable of displaying the original files in the backend file server, the authority protecting section with a predetermined authority employed to guarantee the files against being traced, modified, printed, memorize and is copied, furthermore, the authority protecting section of the user's server including an endorsement processing section which having an function of enabling the user with authority-protecting section's approval to put notes and commentary to the files directly by a manner of layer style, and additionally produced an layer style appended file which preserved in the user's sever as well as the user side computer according to the instruction of the authority protecting section, whereby has no any influences on the original files.

2. The file safety managerial system as claimed in claim 1, wherein the isolating and protecting device further including a file code section, a authority managerial section for controlling the information-transmission.

3. The file safety managerial system as claimed in claim 1, wherein the protecting layer including an isolating and protecting device and software.

4. The file safety managerial system as claimed in claim 1, wherein the user's operating layer including a user's server and software.
